(19) United States
(12) Patent Application Publication
(10) Pub. No.: US 2008/0131822 A1
(43) Pub. Date: Jun. 5, 2008

(54) Method of fabricating imprint lithography template

(75) Inventors: Chen-Liang Liao, Hsinchu (TW); Jiann-Heng Chen, Puli Township (TW); Fon-Shan Huang, Hsinchu (TW)

Correspondence Address: TROXELL LAW OFFICE PLLC;SUITE 1404, 5205 LEESBURG PIKE, FALLS CHURCH, VA, 22041, US

(73) Assignee: National Tsing Hua University, Hsinchu (TW)

(21) Appl. No.: 11/654,042

(22) Filed: Jan. 17, 2007

(30) Foreign Application Priority Data
Nov. 30, 2006 (TW) 095144552

(51) Int. Cl. G03C 5/00

(52) U.S. Cl. 430/347

(57) ABSTRACT

A template, stamp or mold is fabricated by using a low-k material. The structure of the low-k material is transformed when it is baked in a novel heating process. Thus, the template is fabricated to obtain a high hardness and a high aspect-ratio with a low dose of electron beam lithography and an optimized baking process. Consequently, the residual; layer at photoresist bottom is reduced and the time for reactive ion etching is saved. In the end, the stability and the integrity is improved. Hence, the present invention is a solution for fabricating a template, stamp or mold with the feature size from sub-micrometer down to nanometer level.

### FIELD OF THE INVENTION

The present invention relates to fabricating a template; more particularly, relates to obtaining a template for a UV-imprinting lithography and a micro-contact printing.

### DESCRIPTION OF THE RELATED ARTS

According to the ITRS (International Technology Road map for Semiconductors Conference) 2005 update, the 45 nm gene ration will become standard in 2010. As design rules of ULSI continue to shrink, interconnect processes must be compatible with device road maps and meet manufacturing targets. As conventional projection lithography reaches its limits, next generation lithography (NGL) tools may provide means to further shrink patterns; but it is expected to have a price tag that is prohibitive for many companies. The development of both light source and optics to support the sources are primarily responsible for cost rising of NGL tool.

In 1995, Stephen Y. Chou, etc. revealed an imprint lithography technology (Stephen Y. Chou, Peter R. Krauss, and Preston J. Renstrom, “Imprint of Sub-25 nm via and Trenches in Polymers,” Appl. Phys. Lett., 20-21, 67, 1995.) It is essentially a micro-molding process in which a topography of a template defines the patterns created on a substrate. The imprint process is accomplished by heating a resist above its glass transition temperature and imparting with a relatively large force to transfer the patterns into the heated resist. It creates a resist relief pattern by deforming the resist physical shape with embossing, rather than by modifying the resist chemical structure with radiation or self-assembly. The difference in principles makes nano imprint lithography capable of producing sub-10 nm features over a large area with a high throughput and low cost. A variety of different devices, such us ring transistors, MOSFET, MESFET, are fabricated by a number of different researchers using this approach.

Another prior art, step and flash imprint lithography, is revealed by C. G. Wilson, etc. in 1999 (P. Ruchhoeft, M Colburm, B. Choi, H. Nounu, S. Johnson, T. Bailey, S. Damle, M. Stewart, J. Ekerdt, S. V. S reenivasan, J. C. Wolfe, and C. G. Wilson, “Pattern Curved Surfaces: Template Generation by Ion Beam Proximity Lithography and Relief Transfer by Step and Flash Imprint Lithography,” J. Vac. Sci. Technol., B17 (6), 2965-2969, 2002.) A low-viscosity photoresist is used here to be sprayed according to stepper field addresses to avoid uneven critical width formed by over-thickness of the left-off layer obtained by uneven spin-on coating. The technology is similar to ULSI and is more suitable for the industry applications.

A third prior art is revealed by M. Bender, etc. in 2000, named ultraviolet nanoimprint lithography (UV-NIL) (M. Bender, M. Otto, B. Hadam, B. Vratzov, B. Spangenberg, and H. Kurz, “Fabrication of Nanostructures Using a UV-Based Imprint Technique,” Microelectronic Engineering, 53, 233-236, 2000.) The UV-NIL is a derivative of NIL which addresses the issue of alignment by using a transparent template facilitating a conventional overlay alignment. In addition, the imprint process is performed at low pressure (15 psi) and at room temperature, which minimizes magnification and distortion errors. Thus, this prior art obtains higher productivity with lower cost than general hot imprint lithography. Nevertheless, the UV-NIL technology and the hot imprint lithography are both limited to fabricating templates; and the line width and quality of the template decide the quality of the imprint result.

The template, stamp or mold fabricated by using the U V-NIL technology can be obtained by first etching a chromium on a quartz and then etching the quartz or an oxide layer on the quartz. In 2002, T. C. Bailey, etc. revealed two methods (T. C. Bailey, D. J. Resnick, D. Mancini, K. J. Nordquist, W. J. Dauksher, E. Ainley, A. Talin, K. Gehoski, J. H. Baker, B. J. Choi, S. Johnson, M. Colburn, M. Meissl, S. V. Sreenivasan, J. G. Ekerdt, C. G. Willson, “Template Fabrication Schemes for Step and Flash Imprint Lithography,” Microelectronic Engineering, 61-62, 461-467, 2002) One method, as shown in FIG. 3A, is to coat a chromium element 312 on a quartz substrate 311 followed with a photoresist layer 313 coated. Then an electron-beam lithography (EBL) exposure 314 is processed; the chromium metal having the photoresist as a pattern mask is etched 315; and then a reactive ion etching (RIE) is processed to obtain a template 317 from the oxide layer. The other method, as shown in FIG. 3B, is to coat a transparent conductive layer 322 and a silicon dioxide 323 on a quartz substrate 321 and is followed with coating a photoresist layer 324. Then the EBL exposure 325 is processed; and then the RIE 326 is processed to obtain a template 327. What are common to these two methods include the EBL exposure and the photoresist as a pattern mask for the RIE to obtain the template. Yet, the EBL process takes time; and the following RIE requires controls on critical dimension, shape and aspect ratio of structure, etc. In addition, the photo resist having a structure of a high aspect ratio may be collapsed with imperfection on etching and so distortion of the line width occurs. All these impede the fabrication of the template and the application of the imprint lithography.

In 2002, C. G. Wilson, etc. revealed that a hydrogen silsesquioxane (HSQ) on a quartz can be directly exposed through an electron beam lithography to obtain a stable oxide as a pattern on a template/stamp/mold (D. P. Mancini, K. A. Gehoski, E. Ainley, K. J. Nordquist, D. J. Resnick, T. C. Bailey, S. V. Sreenivasan, J. G. Ekerdt, and C. G. Willson, “Hydrogen silsesquioxane for direct electron-beam patterning of step and flash imprint lithography template,” J. Vac. Sci . Technol., B20 (6), 2896-2901, 2002). As shown in FIG. 3C, a quartz substrate 331 is first coated with 60 nanometers (nm) of indium tin oxide (ITO) 332 and then is spin-on coated with 100 nm of HSQ 333. Then, the HSQ on the quartz substrate is exposed 334 to obtain a stable oxide as a pattern of template directly. The HSQ is an oxide layer spun and has a proper sensitivity to electron beam so that a negative photoresist characteristic is obtained with excellent processing latitude after the EBL exposure and is not non chemically amplified. Thus, the HSQ after the exposure is a stable oxide to be a pattern on the template without the above problems concerning chromium element, critical dimension, etc. However, the HSQ has a thickness much thinner than that of a general UV photoresist which is about 300 nm. A reactive ion etching is required to remove residual layer of photoresist at bottom of the imprint region, which increase the complexity of process. The electron beam used has a large dose and related process time is too long so that the cost is increased. In the same time, the HSQ is heated to 200° C. only, which results in instability in HSQ structure. So, the HSQ is porous inside to absorb water vapor and the structure may be thus changed easily. This limits its applications for the imprinting process. Hence, the prior arts do not fulfill users' requests on actual use.

### SUMMARY OF THE INVENTION

The main purpose of the present invention is to provide a high resolution, high hardness, high aspect ratio, high stability, and low-cost imprint template with low-dose electron beam lithography, a pre-baking, a post-baking, and a hard-backing of step-baking technologies.

The second purpose of the present invention is to provide an imprint lithography template at low temperature.

The third purpose of the present invention is to provide an imprint lithography template using a stable and quartz-like HSQ/SOG (spin-on glass).

The forth purpose of the present invention is to provide an imprint lithography template using different thickness HSQ/SOG(spin-on glass) with different solvent concentration.

The fifth purpose of the present invention is to provide an optimized condition to get high-aspect-ratio HSQ/SOG imprint lithography templates with different baking condition and solvent concentration.

To achieve the above purposes, we find novel method to convert cage-like HSQ into quartz-like HSQ to improve the stability and hardness of HSQ film. The present invention is a method of fabricating an imprint lithography term plate, where a substrate coated with a transparent conductive layer is cleaned with a chemical solution; then a low-k material is spin-on coated on the substrate to be pre-baked with a step-baking; then the substrate is processed through an electron beam lithography exposure, a post-baking, and then is developed with a developing solution; and, at last, the substrate is processed through a hard-baking to obtain a template. Accordingly, a novel method of fabricating an imprint lithography template is obtained.

### BRIEF DESCRIPTIONS OF THE DRAWINGS

The present invention will be better understood from the following detailed description of the preferred embodiment according to the present invention, taken in conjunction with the accompanying drawings, in which

FIG. 1 is the flow view showing the preferred embodiment according to the present invention;

FIG. 2 is the structural view of the preferred embodiment; and

FIG. 3A to FIG. 3C are the views of the prior arts.

### DESCRIPTION OF THE PREFERRED EMBODIMENT

The following description of the preferred embodiment is provided to understand the features and the structures of the present invention.

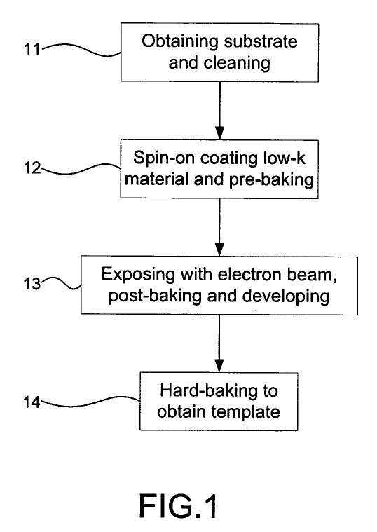

Please refer to FIG. 1 which is a flow view showing a preferred embodiment according to the present invention. As shown in the figure, the present invention is a method of fabricating an imprint lithography term plate, comprising the following steps:

(a) Substrate obtaining and cleaning 11: A substrate coated with a transparent electrode is obtained to be cIeaned with a chemical solution, where the substrate is made of glass or quartz; and the transparent electrode is made of indium tin oxide (ITO), indium zinc oxide (IZO), indium gallium zinc oxide (IGZO) or zinc oxide (ZnO).

(b) Low-K material spin-on coating and pre-ba king 12: The substrate is spin-on coated with a low-k material to be pre-baked, where the low-k material is a spin-on glass (SOG), hydrogen silsesquioxane (HSQ), methylsilsesquioxane (MSQ), organosilicate glass (OSG), a polymer, porous MSQ, a porous polymer or an ultra-low-k material; the pre-baking is a step-baking, a high-low baking or a programmed baking; and the pre-baking is done through a hotplate, an oven or an illumination heating device.

(c) Electron-Beam exposing, posting baking, and solution developing 13: The low-k material is processed through an electron beam lithography exposure and a post-baking, and is developed with a developing solution. The post-baking is done through a hotplate, an oven or an illumination heating device.

(d ) Hard-baking to obtain a template 14: At last, the substrate is hard-baked to obtain a template, a stamp or a mold, where the hard-baking is a step-baking, a high-low baking or a programmed baking; and the hard-baking is done through a hotplate, an oven or an illumination heating device.

Thus, a novel method of fabricating an imprint lithography template is obtained.

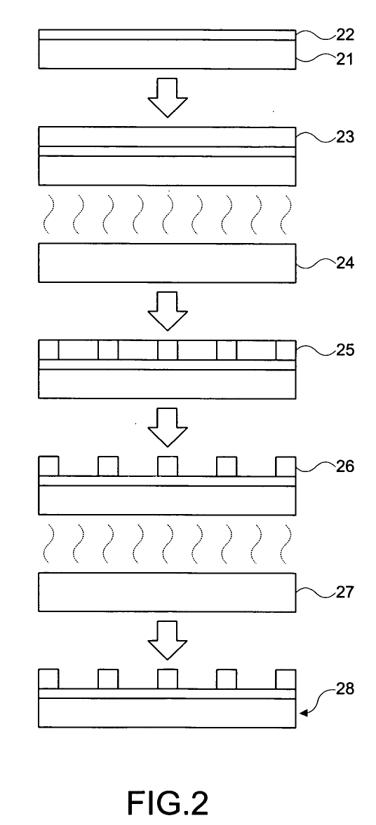

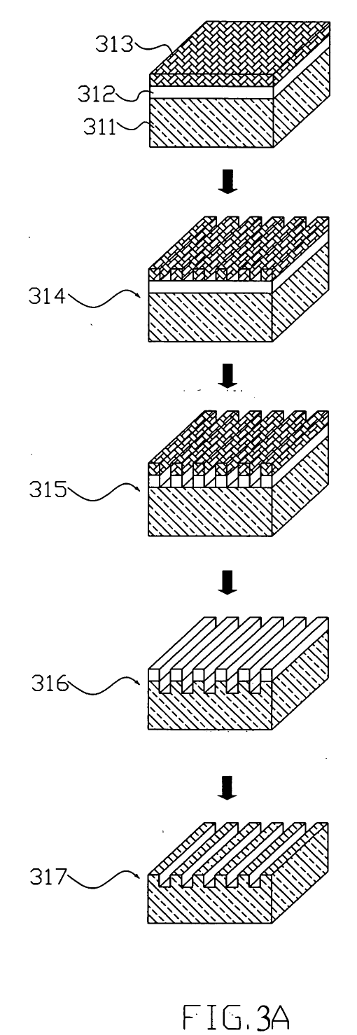

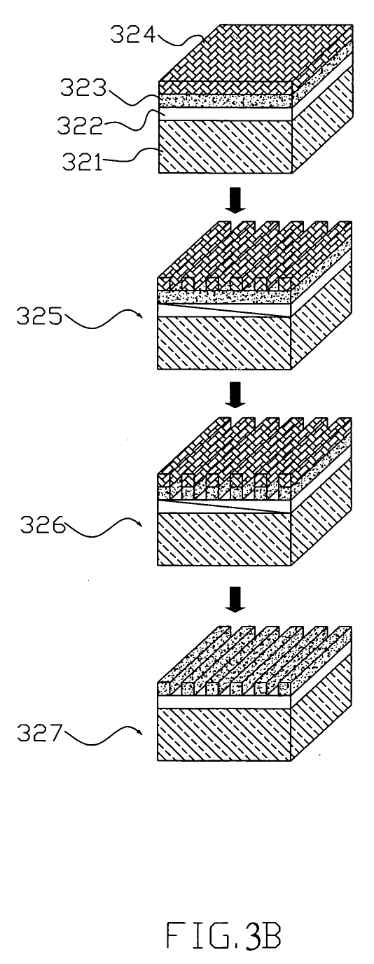

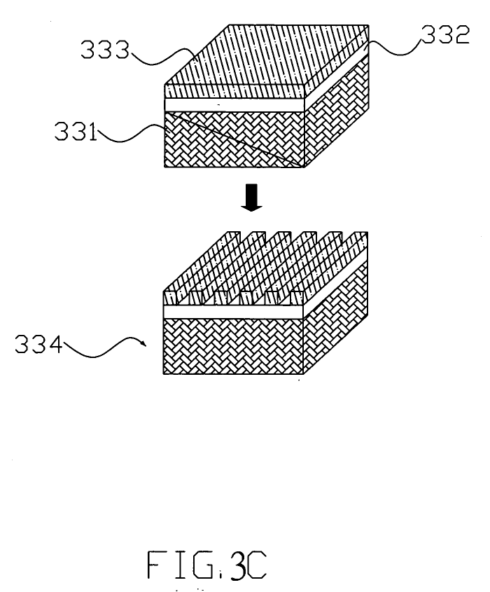

Please refer to FIG. 2, which is a structural view of the preferred embodiment. As shown in the figure, when fabricating the preferred embodiment, a glass substrate 21 coated with ITO 22 is obtained to be cleaned with an RCA (Radio Corporation of America) chemical solution. Then, the substrate is spin-on coated with 450 nm (nanometer) of HSQ 23 (FOX-15). And then a pre-baking of step-baking is processed with a hotplate 24. The pre-baking starts from 40 Celsius degrees (° C.); and each of the following steps raises 20° C. for staying 1 to 2 minutes (min) until 120° C. for staying 3 min. Then the HSQ 25 is exposed through a low-dose electron beam lithography whose dose is 360 μC/cm². To improve the adhesion between HSQ/SOG and substrate, a post-baking is processed with a hot plate at 280° C. for staying 2 min. And then a development 26 is processed with a developing solution of Tetramethyl ammonium hydroxide (TMAH). At last, a hard-baking of step-baking is processed with a hotplate 27. The hard-baking starts from 200° C.; and each of the following steps raises 50° C. for staying 10-15 min until 350° C. Thus, a template 28 is obtained.

However, if the HSQ is baked through one step only, the root-mean-square (Rms) of surface roughness is 1.377 nm; and, if the HSQ is baked through steps, the Rms of surface roughness is 0.525 nm. It means that the surface roughness and the structure characteristics of the HSQ film can be improved by the step-baking process. Because the step-baking improves transparency characteristics of the ITO film as well, transparency of the whole substrate is increased and thus a better UV (ultra-violet) transparency of the present invention is obtained than that of a glass substrate having the ITO yet not coated with the HSQ. And the template obtained through the present invention has a hardness of about 19˜21 Gpa, greater than 8.8 GPa of a common quartz. Hence, the present invention can be applied not only in an UV imprint lithography using a low pressure (5˜15 psi) but also in a micro-contact printing. The template obtained through the present invention has an almost perpendicular side wall to the bottom of line; and an aspect ratio of a structure of the present invention is 5.5, much higher than a general 3.3. Thus, the present invention can use a UV photoresist of PAK-01-200 having a thickness of 350˜390 nm for 60 sec (second) of imprinting by using a device of NX-2000 with a pressure smaller then 15 psi. The transferred lines obtained through the imprint are almost the same as the lines on the template; and, the lines remain the same even after a period of time.

To sum up, the present invention is a method of fabricating an imprint lithography template, where a substrate having a low-k material is spin-on coated for pre-baking; then the substrate is processed through an electron beam lithography exposure and a post-baking, and then is developed with a developing solution; and then the substrate is hard-baked to obtain the template.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A method of fabricating an imprint lithography template, comprising steps of:
(a) obtaining a substrate
(b) spin-on coating a low-k material on said substrate and pre-baking;
(c) exposing said substrate through lithography with an electron beam having low dose and processing a post-baking, and then developing with a developing solution; and
(d) hard-baking said substrate to obtain a template.

2. The method according to claim 1, wherein said substrate is made of a material selected from a group consisting of glass and quartz.

3. The method according to claim 1, wherein said substrate is coated with a transparent conductive layer; and wherein said transparent conductive layer is made of a material selected from a group consisting of indium tin oxide (ITO), indium zinc oxide (IZO), indium gallium zinc oxide (IGZO) and zinc oxide (ZnO).

4. The method according to claim 1, wherein said low-k material is selected from a group consisting of a spin-on glass (SOG), hydrogen silsesquioxane (HSQ), methylsilsesquioxane (MSQ an organosilicate glass (OSG), a polymer, porous MSQ, and a porous polymer.

5. The method according to claim 1, wherein said low-k material is an ultra-low-k material.

6. The method according to claim 1, wherein said low dose is lower than 800 μC/cm².

7. The method according to claim 1, wherein said pre-baking is processed through a device selected from a group consisting of a hotplate, an oven and an illumination heating device.

8. The method according to claim 1, wherein said pre-baking is processed in a way selected from a group consisting of a step-baking, a high-low baking and a programmed baking.

9. The method according to claim 1, wherein said post-ba king is processed through a device selected from a group consisting of a hotplate, an oven and an illumination heating device.

10. The method according to claim 1, wherein said post-baking is processed in a way selected from a group consisting of a step-baking, a high-low baking and a programmed baking.

11. The method according to claim 1, wherein said hard-baking is processed through a device selected from a group consisting of a hotplate, an oven and an illumination heating device.

12. The method according to claim 1, where in said hard-baking is processed in a way selected from a group consisting of a step-baking, a high-low baking and a programmed baking.
